(19) United States
(12) Patent Application Publication
(10) Pub. No.: US 2013/0331153 A1
(43) Pub. Date: Dec. 12, 2013

(54) METHOD AND APPARATUS FOR WEARABLE WIRELESS SPEAKERPHONE

(71) Applicant: Charles Krimstock, Laguna Niguel, CA (US)

(72) Inventor: Charles Krimstock, Laguna Niguel, CA (US)

(21) Appl. No.: 13/911,775

(22) Filed: Jun. 6, 2013

Related U.S. Application Data
(60) Provisional application No. 61/658,842, filed on Jun. 12, 2012.

(51) Int. Cl. H04M 1/60

(52) U.S. Cl. CPC H04M 1/6041
USPC 455/569.1

(57) ABSTRACT

A wearable wireless speakerphone that can be worn by a user on their bodies either by attachment to their garments or other accessories by means of a variety of clips, magnets or worn around the neck using a lanyard to provide a hands-free means of communication with a smart phone or other smart devices. An exemplary embodiment of the invention combines the wireless speakerphone of the invention with a corporate badge or other badges worn by a user in the course of their work to enable them to communicate with their smart phones or other devices or with their co-workers smart phones or devices so that their hands are free to accomplish the tasks that they are engaged in. The wireless speakerphone uses a PCB circuitry for wireless and/or hands-free connectivity with the latest Bluetooth protocol 4 or other advanced protocols including, but not limited to RF, RFID, NFC, WIFI protocols.

### CROSS REFERENCE TO RELATED APPLICATION

This application claims priority to U.S. Provisional Patent Application Ser. No. 61/658,842 which is incorporated herein in its entirety.

### FIELD OF THE INVENTION

The present invention is generally related to wireless devices. More particularly, the invention is related to a wireless speakerphone that can be worn on the body of a user through various attachments means.

### BACKGROUND OF THE INVENTION

The advent of telecommunication devices such as, cell phones, smart phones, pagers, iPads, PDA's and other similar devices, has also spurred the desire and need to be able to remotely communicate with these devices, leaving the user's hands free to perform other tasks concomitantly. Prior art in this field have been primarily focused on hands-free communication with cellular phones while navigating a vehicle. A majority of the communication devices used for this purpose are ones that are placed on the dashboard, sun visor, or other areas in the vicinity of the user while navigating a vehicle. U.S. Pat. No. 8,380,254 (Linhard) describes a speech device for a hands-free system in a vehicle having at least one microphone arranged on a guide element encompassing a safety belt. U.S. Pat. No. 8,301,26 (Kakehi) is an in-vehicle hands-free apparatus that establishes a concurrent communication between a BT interface device and a cellular phone.

Prior art in the field of wearable hands-free speakerphones capable of communicating with wireless devices is limited to U.S. Pat. No. 6,895,261 (Palamides) which describes a portable, wireless communication apparatus integrated into a garment. The apparatus comprises of a host unit with a docking station attached to an unobtrusive location on the interior of a garment such as the torso area, an interactive communication unit attached to the end of the garment sleeve, collectively providing wireless communication capabilities, such as paging, advanced messaging, voice communications, and/or entertainment features. The apparatus of this prior art requires the concomitant functioning of disparate units attached to various parts of a garment to wirelessly communicate with other devices.

The present invention is a wearable speakerphone that has the capability to wirelessly communicate with smart phones and similar smart devices without the need to be integrated into the garment worn by the user. The apparatus for the present invention can be attached to the garment of a user by various attachment means that do not require integration into the garment. In addition, the wireless speakerphone of the invention can also be used as a stand-alone device without attachment to the body of a user. The exemplary features of the wireless speakerphone of the present invention will become obvious to one skilled in the art through the summary of the invention, detailed description of the invention, and the claims that follow.

### SUMMARY OF THE INVENTION

The present invention is a wireless speakerphone that is configured to attach to the body of a user through a variety of attachments means. The capability of the wireless speakerphone of the present invention to attach to the garment worn by a user through the use of clips, magnetic holders and other attachment means and/or hung from a lanyard around the neck of the user, makes it non-intrusive compared to speakerphones in the prior art such as Bluetooth (BT) type devices which require placement in the ear of the user. When the speakerphone of the present invention is paired with a compatible smart phone or other smart device, it becomes a convenient, hands-free, wireless personal communication device.

In an exemplary embodiment of the wireless speakerphone of the present invention, the speaker for the speakerphone is housed in a forward facing speaker housing assembly which has a concave-shaped hard shell, mesh grill exterior, capable of collapsing when compressed, to activate the speaker through a micro-switch. Multi-functions are possible by varying the number of times the mesh grille is compressed. For example, a press and hold for three seconds will control the on/off cycles. In this embodiment, the speaker housing assembly also has a micro-USB (universal serial bus) charging port located at one end and an LED (light-emitting diode) indicator window located on the opposite end of the housing structure.

In the exemplary embodiment of the present invention, the wireless speakerphone uses a printed circuit board (PCB) for wireless and/or hands-free connectivity with the latest Bluetooth (BT) protocol 4 or other advanced protocol including, but not limited to RF (radio frequency), RFID (radio frequency identification), NFC (near filed communication), WIFI (wireless fidelity) protocols. Other exemplary features of the wireless speakerphone of the present invention include, a micro-switch, capacitive sensor, vibrating motor, full duplex voice technology and noise canceling technology which helps to minimize unwanted background noises from getting through to the person on the other end of a call. The directional speaker system of the wireless speakerphone of the present invention, allows for clear sounds even from a distance of up to one meter or more from the user's ears.

In an embodiment of the wireless speakerphone of the present invention, a smart phone or other smart device application for the wireless speakerphone would allow the user to control many functions. For example, a proximity function would alarm the user by sound and vibration if the smart phone has been left behind by a pre-set distance. Other user-controllable features would include loudness settings, alert settings, alarm tones, and emergency dialing. The smart phone could also be used in reverse to locate the wireless speakerphone.

In the exemplary embodiment of the present invention, the wireless speakerphone is light weight and measures just under 1.5 inches (39.1 mm) in diameter, is fully self contained and re-chargeable through the USB port located within the speaker housing assembly.

An exemplary embodiment of the present invention combines the wireless speakerphone with a wearable identification badge (ID) badge to replace a typical corporate ID badge reel with another badge reel that has the wireless speakerphone attached to the badge. Thus the interchangeable speakerphone module and badge reel combination embodiment of the invention is engineered to replace a typical corporate ID badge reel with a badge reel plus micro-sized speakerphone and becomes a wearable aesthetically pleasing designer device. In this embodiment, the miniature size and light weight of the wireless speakerphone adds very little bulk or weight to the traditional ID badge reel. In this embodiment, the wireless speakerphone when combined with an ID badge of any size or shape can also be worn clipped to a shirt pocket, shirt collar, or belt through an alligator or other type of clip, or worn around the neck using a lanyard.

In a related exemplary embodiment of the present invention, the wireless speakerphone can be attached to a stationary stand-alone ID badge holder without the need to attach it to an ID badge retractable reel for clipping on to a garment worn by the user, showcasing the versatility of the wireless speakerphone as one device with multiple uses.

In yet another embodiment of the present invention, the wireless speakerphone may also be used to form the ID badge worn by others such as doctors, nurses, paramedics, fire fighters, police officers, first responders, or other professionals for whom the ability to wirelessly communicate in a hands-free fashion might prove beneficial in an emergency situation of saving a life.

Related embodiments of the wireless speakerphone of the present invention would include integration with heart rate and blood pressure monitors, temperature, humidity control and other sensors both standard and miniaturized, GPS and other systems that can benefit from the incorporation of a wireless speakerphone that is capable of communicating with smart devices.

Other embodiments of the present invention would incorporate the wireless speakerphone with ornamental jewelry, necklaces, watch bands, and sports gear.

Yet, another embodiment of the wireless speakerphone of the present invention would be a line of clothing with a sewn-in magnet that would allow for quicker attachment and detachment of the wireless speakerphone module with garments.

The foregoing summary of the embodiments of the present invention should not be construed to limit the scope of the invention. In this summary of the invention and in the specification in general the various references to “the exemplary embodiment,” “an exemplary embodiment,” “related embodiment”, “yet another embodiment,” and “other embodiments” do not necessarily refer to the same embodiment (s). Rather, these references to the various embodiments in general mean that a particular feature, structure, or characteristic described in conjunction with an embodiment is included in at least some embodiments, but not necessarily all embodiments of the invention. The objects, embodiments, and features of the wireless speakerphone of the present invention as described in this summary of the invention will be further appreciated and will become obvious to one skilled in the art when viewed in conjunction with the accompanying drawings, detailed description of the invention, and the appended claims.

### BRIEF DESCRIPTION OF THE DRAWINGS

FIG. 1 is a perspective view of the forward facing, hard shell, mesh grille of the wireless speakerphone of the present invention.

FIG. 2 is a perspective side view of the wireless speakerphone of the present invention with an alligator clip attachment means.

FIG. 3 is a perspective view of the forward facing, hard shell, mesh grille of the wireless speaker phone of the present invention attached to an extendable and retractable cable reel with an ID badge holder.

FIG. 4 is a perspective side view of the speakerphone of the present invention, illustrating an alligator clip in combination with an ID badge holder arrangement.

FIG. 5 is a perspective view of a nurse wearing the wireless speakerphone of the present invention linked to her ID badge and hung from her neck through a lanyard.

FIG. 6 is an exploded perspective view of the internal components of the speaker assembly of the present invention.

FIG. 7 is a plan view of the inside front compartment of the speaker assembly structure illustrating the back side of the mesh grille and the microphone attached to it.

FIG. 8 is a second embodiment of the wireless speakerphone of the present invention magnetically clipped to the garment of a user.

FIG. 9 is an exploded front, top, and side view of the components of the second embodiment of the wireless speakerphone of the present invention.

FIG. 10 is another exploded view of the second embodiment of the wireless speakerphone of the present invention.

FIG. 11 illustrates the use of a name badge with the second embodiment of the wireless speakerphone of the present invention.

FIG. 12 is an exploded view of the second embodiment of the wireless speakerphone of the present invention when used with a name badge.

### DETAILED DESCRIPTION OF THE INVENTION

The present invention is a wireless speakerphone that can be worn by a user on their bodies either by attachment to their garments or other accessories to provide a hands-free means of communication with a smart phone or other smart devices. An exemplary embodiment of the invention combines the wireless speakerphone of the invention with a corporate badge or other badges worn by a user in the course of their work to enable them to communicate with their smart phones or other devices or with their co-workers smart phones or devices so that their hands are free to accomplish the tasks that they are engaged in.

The wireless speakerphone of the present invention is a hands-free full duplex speakerphone utilizing the latest Bluetooth Low Energy protocol. Its tiny, miniature size and design measuring just over 1.5 inches (39.1 mm) in diameter adds minimal weight to an ID badge reel when worn on a lanyard around a user's neck. The wireless speakerphone of the present invention allows for direct access to the native voice command functions of today's smart phones, further extending the voice control capability and allowing for hands and ears-free communication.

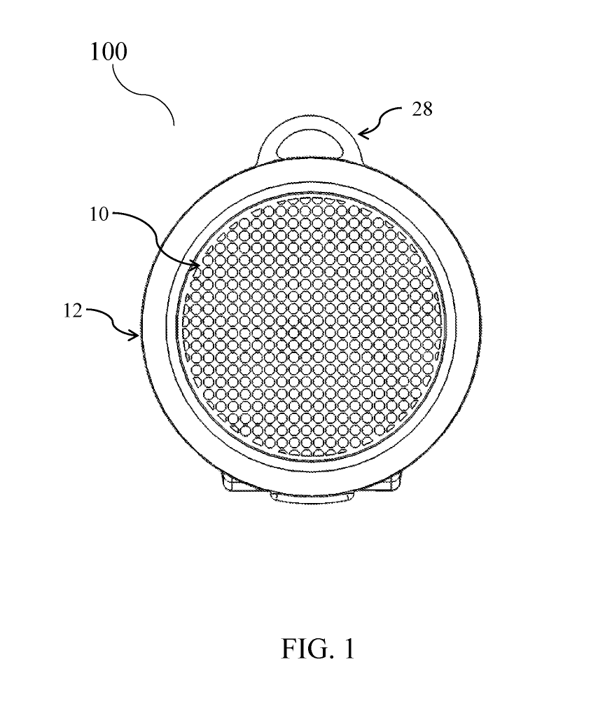

Referring now to the drawings, more particularly to FIG. 1 a perspective view of the forward facing, hard shell, mesh grille 10 of the wireless speakerphone 100 of the present invention is illustrated. The mesh grille 10 acts as a large mechanical switch that is integrated on its back side with a micro-switch in contact with the rear casing (not seen). The mesh grille 10 is integrated with a front casing 12 which houses the integral components (not seen) of the wireless speakerphone 100 immediately behind the mesh grille 10. The operation of the wireless speakerphone is initiated by depressing/pressing the mesh grille 10 which in turn activates the printed circuit board (PCB) mounted micro-switch by making contact with a rear casing (not seen). The front casing 12 becomes a mechanical button that has to be physically depressed about 0.5 mm to activate the micro-switch on the PCB. Multi functions are possible by varying the number of presses on the mesh grille 10. For example, a press and hold of the mesh grille 10 for three seconds will control power on/off cycles. A tap, tap, or double tap on the mesh grille 10 would signal the rejection of an incoming call. By way of another example, a long press (1.5 seconds) on the mesh grille 10 would invoke access to the paired smart phones native voice command features. With the voice command access feature, the wireless speakerphone 100 of the present invention becomes an extension of the smart phones features and functions. For example, the user would be able to access the smart phones messaging application, compose a message, and send the message to a selected party simply by using only voice commands while the smart phone stays in the user's pocket, purse, backpack, or charger the entire period of communication. FIG. 1 also illustrates a hook 28 to thread an optional lanyard if the user wishes to hang the wireless speakerphone 100 alongside the ID badge of the user.

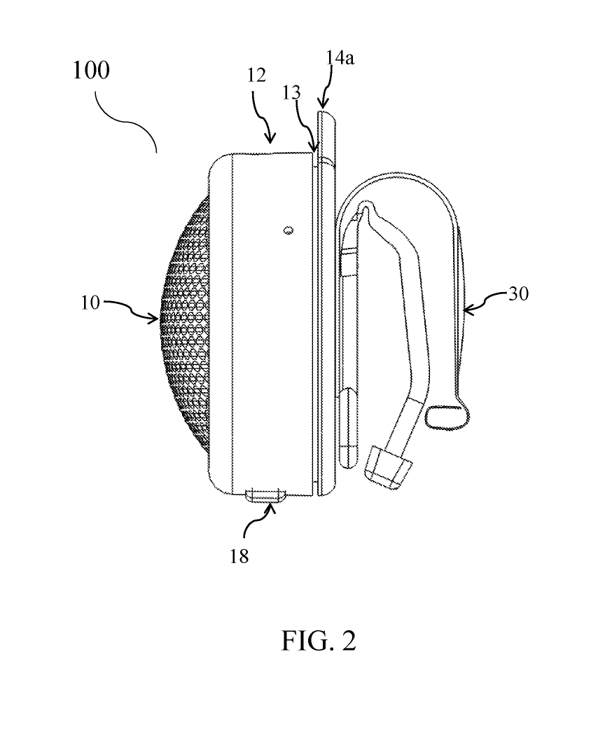

FIG. 2 is a perspective side view of the wireless speakerphone 100 of the present invention with a removable alligator clip 30 that can be used to clip the wireless speakerphone 100 to a shirt pocket, shirt collar, lapel or belt. In this embodiment, the wireless speakerphone 100 can be used with or without an ID badge. The forward facing hard shell, mesh grille 10 integrated with the speaker housing assembly front casing 12 can be depressed to activate or deactivate the wireless speakerphone 100 as described previously through FIG. 1. The method of activation is accomplished by the micro-switch located within the front casing making contact with the rear casing 14a. A small gap 13 allows for the movement of the front casing as it relates to the rear casing 14a. The USB charging port 18 is conveniently located on the underside of the speaker housing assembly to charge the wireless speakerphone 100. When the alligator clip 30 is removed by a Philips-type screw, a magnet can replace it for attachment directly to a shirt or other garment worn by the user.

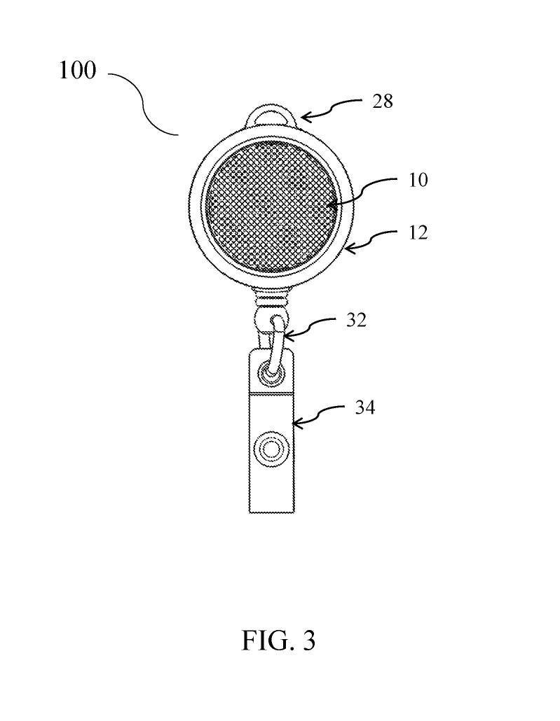

FIG. 3 is a perspective view of the forward facing, hard shell, mesh grille 10 of the wireless speaker phone 100 of the present invention integrated with the front casing 12 of the speaker housing assembly and attached to an extendable and retractable ID badge cable reel 32 hooked to an ID badge strap with snap closure 34. The hook 28 is used to thread the wireless speakerphone 100 through an optional lanyard to place around the user's neck along with the ID badge which will be attached to the ID badge strap with snap closure 34.

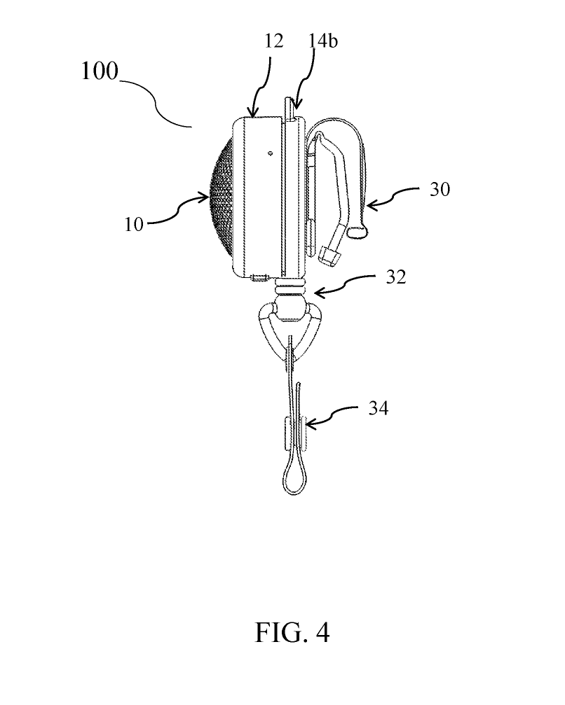

FIG. 4 is a perspective side view of the speakerphone 100 of the present invention, showing the forward facing hard shell, mesh grille 10 and illustrating further the manner in which an alligator clip 30, an ID badge holder arrangement with a retractable reel 32 and an ID badge strap with snap closure 34 are integrated with the speakerphone housing assembly. The essential components of the retractable reel 32 are housed within the rear casing 14b which is a thicker casing than the casing 14a used with the alligator clip in FIG. 2.

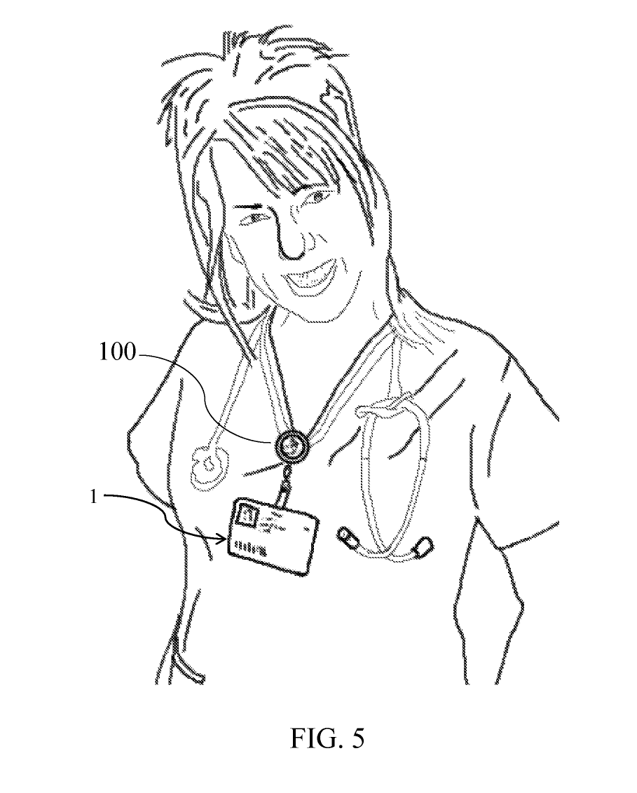

FIG. 5 illustrates a typical user, in this case a nurse or perhaps a doctor with the wireless speakerphone 100 threaded through a lanyard hung around her neck with an ID badge reel holding an ID badge 1 of the user. Besides allowing this user to scan her ID badge 1 through security and other access points during her workday, the convenience of the wireless speakerphone 100 attached to her badge reel allows for multi-tasking and hands-free communication with her smart phone or another phone or other smart device.

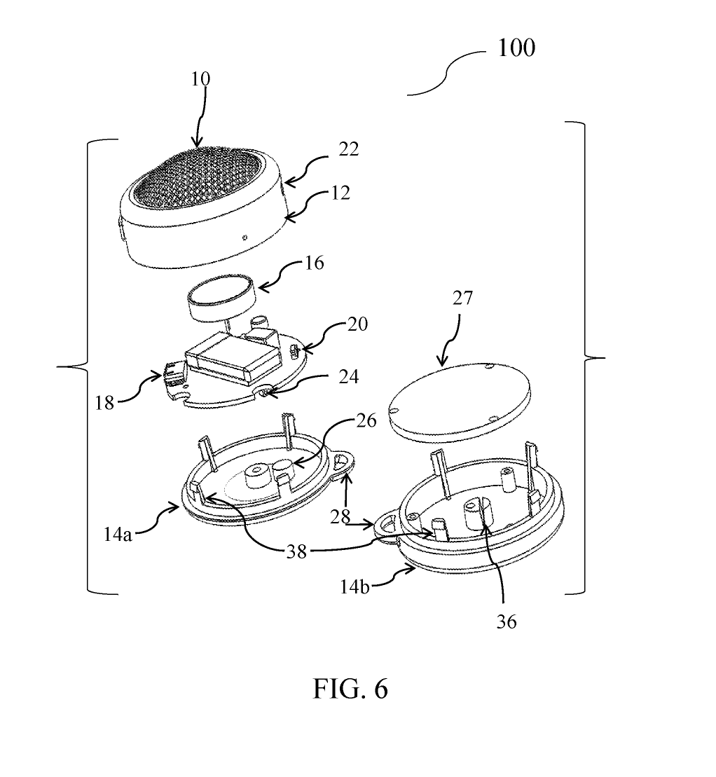

FIG. 6 is an exploded perspective view of the internal components of the speaker assembly of the wireless speakerphone 100 of the present invention. The forward facing hard shell, mesh grille 10 is integrated with the front casing 12 of the speaker assembly. The speaker 16 housed within the speaker assembly structure is shown in relief and is in contact with the microphone (not seen) behind the mesh grille 10. When interlocked with the mesh grille 10 the speaker 16 is angled upward towards the user's ears. The USB cable outlet 18 and the LED light 20 form part of the middle section of the speaker housing assembly. The LED light window 22 is configured on the front outer casing 12 and aligns with the LED light 20 when the parts are assembled. This figure also illustrates the difference in thickness of the rear casing 14b used to house the badge reel assembly as compared to the thickness of the rear casing 14a used with an alligator or other type of clip in FIG. 2. The rear casing 14b housing the badge reel assembly is thicker than the rear casing 14a used for the clips. The rear casing 14b housing the badge reel assembly uses a top cover 27 to hold the reel firmly within the rear casing to prevent it from popping out and also functions to act as the micro-switch contact pad for the badge reel model of the wireless speakerphone 100. In this embodiment of the wireless speakerphone 100 a post 36 located within the rear casing 14b holds the badge reel assembly. In the non-reel embodiment of the wireless speakerphone 100 when the mesh grille 10 is compressed/pressed, it forces the front casing 12 to press upon the rear casing 14a which in turn makes contact with the micro-switch contact pad 26 on the rear casing 14a to activate the micro-switch 24 on the PCB. In the badge reel embodiment, when the mesh grille 10 is compressed, it forces the front casing 12 to press upon the rear casing 14b with the top cover 27 acting as the micro-switch contact pad. The unique design of the locking pins 38 allows for the movement of the front and rear casings when the mesh grille 10 is depressed as well as contributes to a thin design for the wireless speakerphone 100 when it is assembled.

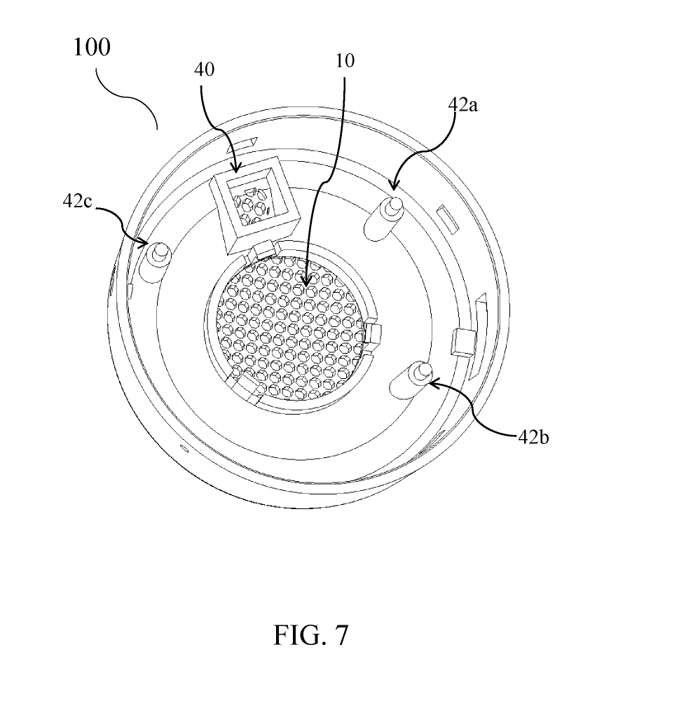

FIG. 7 is a plan view of the inside of the forward facing front compartment of the speaker assembly structure illustrating the back side of the mesh grille 10 and the microphone 40 attached to it. The microphone housing 40 which is completely contained in a separate compartment within the speaker housing assembly reduces noise and feedback. This figure also shows the PCB mounts, 42a, 42b and 42c.

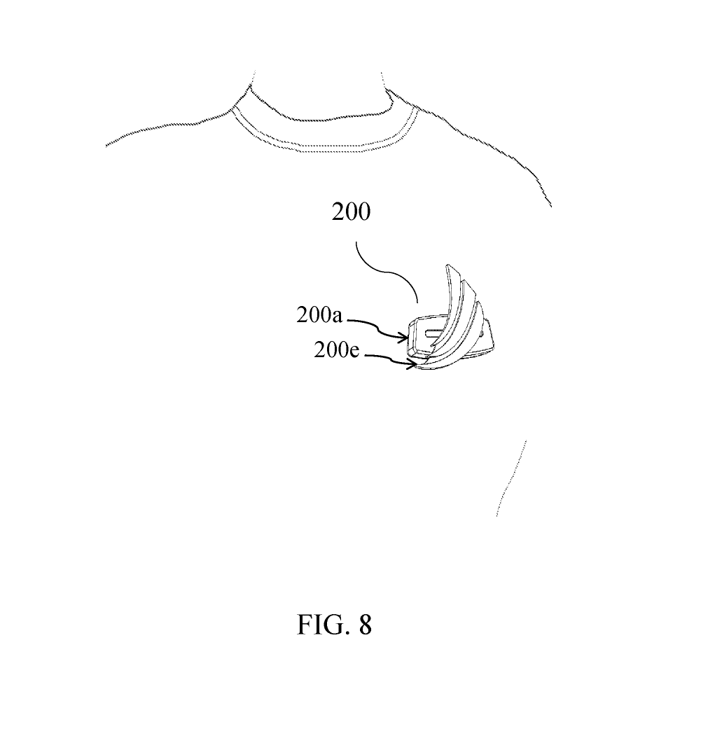

FIG. 8 shows a perspective front view of another embodiment 200 of the wireless speakerphone of the present invention clipped magnetically to the garment of a user. 200e is an ornamental accessory that can be attached to the front of the main speaker housing assembly structure 200a of the wireless speakerphone of this embodiment. When the front facing side of the ornamental accessory is touched or tapped, it activates a proximity sensor, or capacitive switch which enables control of the speakerphone system. In this embodiment, the capacitive switch is activated by contact with the skin just as with the touch screen of a smart phone and therefore does not require the exertion of any pressure on the contact area for activation.

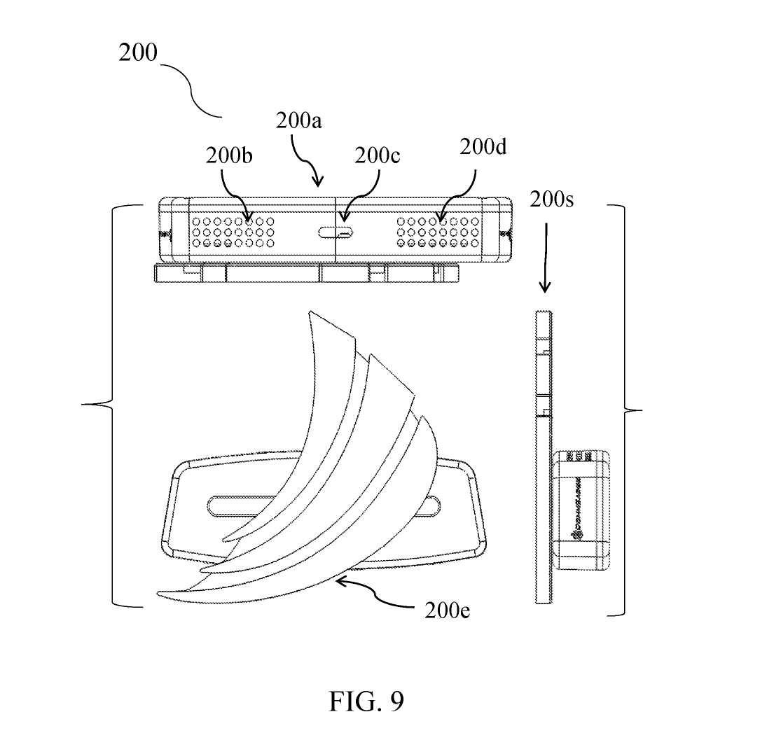

FIG. 9 is an exploded view of the components of the second embodiment 200 of the wireless speakerphone of the present invention. This view shows the main speaker housing assembly structure 200a of the wireless speakerphone with the microphone 200b and the speaker arrangement 200d which are configured to be directed towards the mouth and ears of the user. The LED window 200c is configured at the center of the panel. The detachable, ornamental design assembly 200e can be replaced with other ornamental designs, name badges, or the corporate logo. The main speaker housing assembly structure 200a houses the PCB, battery, microphone, speaker, USB charger port and other components of the wireless speakerphone. 200s is a side view of the speakerphone 200.

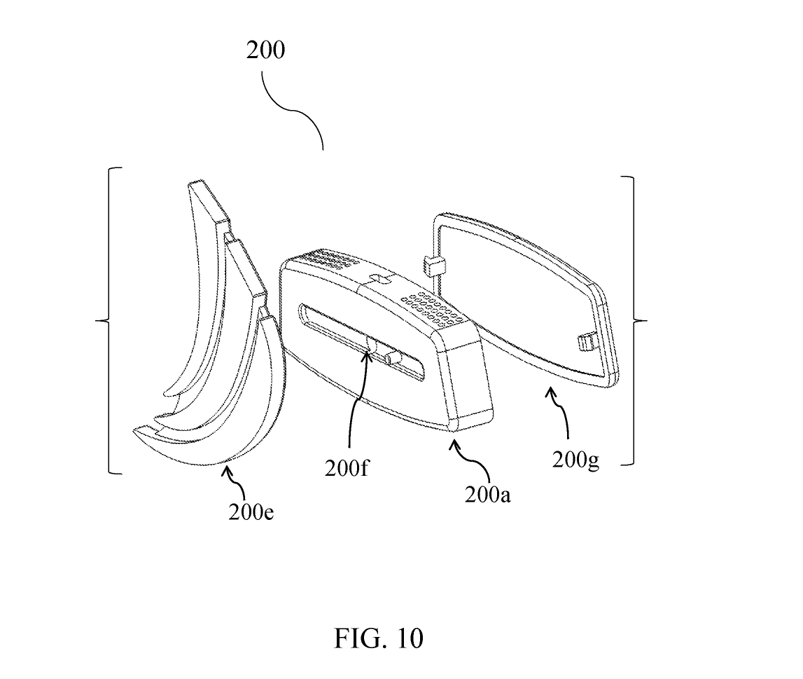

FIG. 10 is another exploded view of the second embodiment 200 of the wireless speakerphone of the present invention with the ornamental accessory 200e separated from the main speaker housing assembly structure 200a of the speakerphone system. This view also shows the location of the proximity sensor/capacitive switch control 200f on the main speaker housing assembly structure 200a and a back cover 200g.

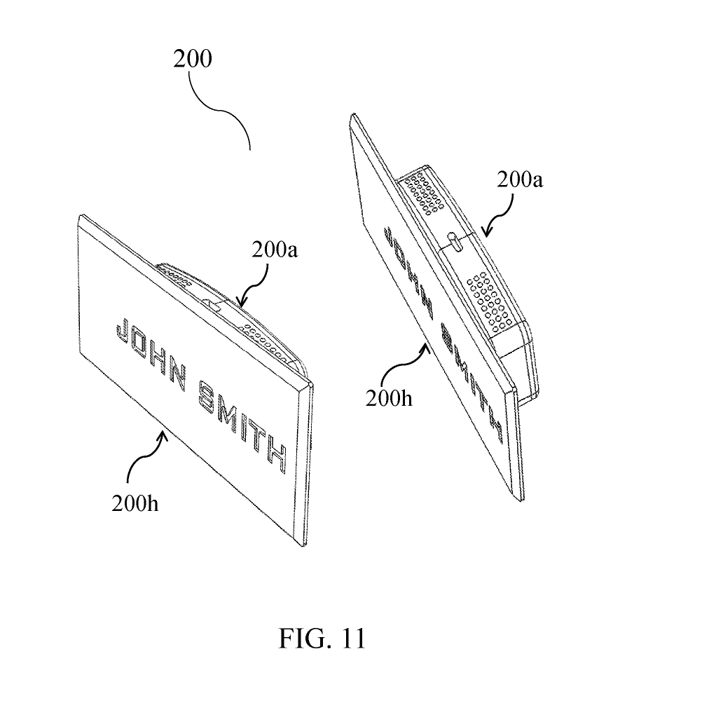

FIG. 11 shows two perspective views of the second embodiment 200 of the wireless speakerphone of the present invention with a name badge 200h attached to the main speaker housing assembly structure 200a. Similar to the ornamental accessory, the name badge 200h when touched or tapped allows for system control through the proximity sensor/capacitive switch. The name badge 200h may be replaced by a corporate logo or an ornamental accessory.

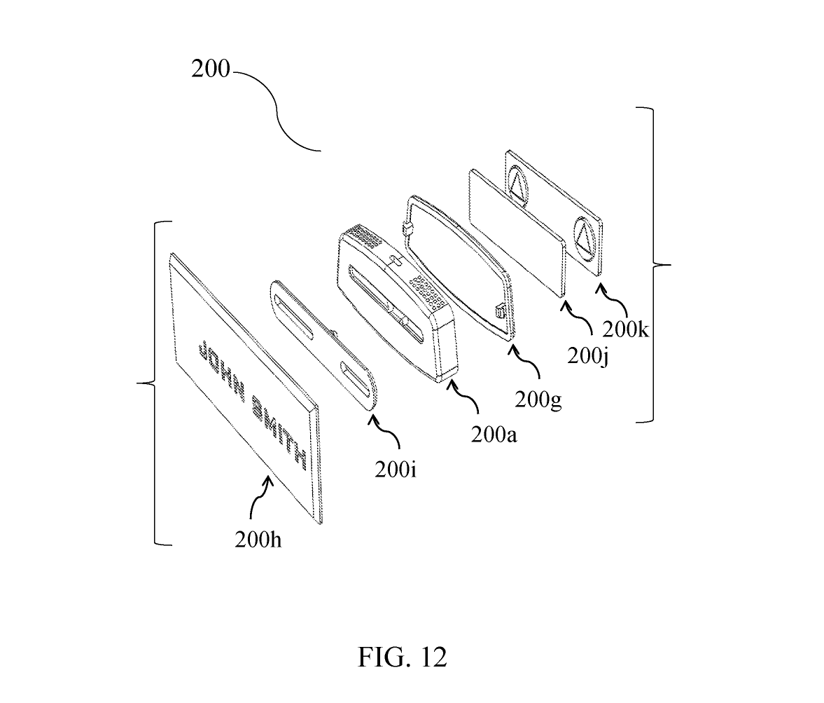

FIG. 12 is another exploded view of the second embodiment 200 of the wireless speakerphone of the present invention with the main housing assembly structure 200a, a badge holder 200i which is attached to the name badge 200h with a tape or other adhesive, a back cover 200g, and magnetic badge attachments 200j and 200k 1.75 inches wide and 0.5 inches in height. The detachable universal name badge holder 200i fits any size name badge with adhesive tape.

The foregoing description of the invention through its figures and preferred embodiments should not be construed to limit the scope of the invention. It is to be understood that the embodiments of the wireless speakerphone of the present invention as described herein do not limit any application or scope of the invention and that the invention can be carried out and practiced in various ways and implemented in embodiments other than the ones outlined in the description above. It should be understood and obvious to one skilled in the art that alternatives, modifications, and variations of the embodiments of the present invention may be construed as being within the spirit and scope of the appended claims.

What is claimed is:

1. A wireless speakerphone apparatus comprising:
a forward facing mesh grille structure member integrated with a front casing of a speaker housing assembly structure;
a microphone structure member integrated on the back side of said mesh grille structure member;
a printed circuit board structure member ;
a micro-switch member attached to said printed circuit board structure member;
a micro-switch contact pad member to activate the said micro-switch member on the said printed board circuit structure member;
a capacitive switch control member;
a proximity sensor member;
a speaker member capable of being activated when the said forward facing mesh grille structure member is compressed to activate the said micro-switch member;
a power source;
a light source;
a bottom cover to enclose the said speaker housing assembly structure. a retractable identification badge reel assembly housed within a rear casing of the said speaker housing assembly structure member;
an identification badge strap with a snap closure; and
a hook to thread an optional lanyard.

2. The wireless speakerphone apparatus of claim 1 wherein the said wireless speakerphone apparatus is capable of wirelessly communicating with cell phones, smart phones and other smart devices.

3. The apparatus of claim 1 wherein the said wireless speakerphone apparatus is activated by compressing the said forward facing mesh grille structure member.

4. The apparatus of claim 1 wherein the said wireless speakerphone apparatus is deactivated by compressing the said forward facing mesh grille structure member.

5. The apparatus of claim 1 wherein the said forward facing mesh grille structure member may be replaced with a rectangular shaped speaker housing assembly structure member to which an ornamental accessory or name badge can be attached which when tapped activates the proximity sensor member or the capacitive switch control member.

6. The apparatus of claim 1 wherein the said wireless speakerphone apparatus is tapped to accept or reject incoming calls for a smart phone.

7. The apparatus of claim 1 wherein the said wireless speakerphone apparatus design directs sound towards the user's ears.

8. The apparatus of claim 1 wherein the said wireless speakerphone apparatus uses the said printed circuit board structure member for wireless and/or hands-free connectivity with advanced wireless protocol systems.

9. The apparatus of claim 1 wherein the said wireless speakerphone apparatus has loudness settings, alert settings, alarm tones and emergency dialing.

10. The apparatus of claim 1 wherein the said wireless speakerphone apparatus is capable of sending an alarm to notify by sound and vibration if a smart phone linked to the said wireless speakerphone has been left behind by a pre-set distance and locating the said wireless speakerphone through a smart phone.

11. The wireless speakerphone apparatus as in claim 1 wherein the said wireless speakerphone apparatus is wearable.

12. The apparatus of claim 1 wherein the said wireless speakerphone apparatus can be attached to an identification badge of a user through the said retractable identification badge reel assembly.

13. The apparatus of claim 1 wherein the said wireless speakerphone apparatus can be attached to the garment of a user using clips.

14. The apparatus of claim 1 wherein the said wireless speakerphone apparatus can be attached to garments with magnetic holders.

15. The apparatus of claim 1 wherein the said wireless speakerphone apparatus can be hung from the neck of a user using a lanyard either by itself or in combination with any identification badge.

16. The apparatus of claim 1 wherein the said wireless speakerphone apparatus is lightweight and miniature in size.

17. The apparatus of claim 1 wherein the said wireless speakerphone apparatus is a stationary stand alone device.

18. The apparatus of claim 1 wherein the wireless speakerphone apparatus has an ornamental design attachment.

19. The apparatus of claim 1 wherein the wireless speakerphone apparatus has a universal name badge attachment.

20. The apparatus of claim 1 wherein the said wireless speakerphone apparatus can be integrated with heart rate and blood pressure monitors, temperature, humidity control and other sensors, both standard and miniaturized.
